(19) United States
(12) Patent Application Publication
(10) Pub. No.: US 2014/0274256 A1
(43) Pub. Date: Sep. 18, 2014

(54) SYSTEM AND METHOD FOR A BLACKJACK HOLD-EM GAME

(71) Applicants: Doug Seidenberg, Las Vegas, NV (US); Neil Glass, Warren, NJ (US); Sean Wooden, Derwood, MD (US)

(72) Inventors: Doug Seidenberg, Las Vegas, NV (US); Neil Glass, Warren, NJ (US); Sean Wooden, Derwood, MD (US)

(21) Appl. No.: 14/207,398

(22) Filed: Mar. 12, 2014

Related U.S. Application Data
(60) Provisional application No. 61/780,315, filed on Mar. 13, 2013.

(51) Int. Cl. G07F 17/32; A63F 1/00

(52) U.S. Cl. CPC G07F 17/3293; A63F 1/00; A63F 2001/003
USPC 463/12; 273/292

(57) ABSTRACT

Methods, computer-implemented methods, systems, tables and computer-readable mediums for playing blackjack hold-em that include receiving a buy-in from each player, calculating a unit, wherein the unit is the value of each hand, calculating total units needed to win a game, dealing player hold cards, wherein the hold cards are dealt face-down, receiving one or more requests for hit cards, wherein the hit cards are dealt face up, instructing each player to turn over their hold cards, determining the winning hand or hands, and paying the winning hand the appropriate unit(s) or unit fraction, minus any house take.

### CROSS REFERENCE TO RELATED APPLICATION(S)

This application claims priority from U.S. Provisional Patent Application. No. 61/780,315, filed on Mar. 13, 2013, entitled, “System and Method for a Blackjack Hold-em Game,” which is hereby incorporated herein by reference in its entirety.

### FIELD

The invention relates generally to betting card games, particularly table and automated blackjack variant games.

### BACKGROUND

Betting card games, such as blackjack, poker, baccarat and others, and their predecessors have been around for centuries. Such card games are played in private homes and small gatherings, but the most prevalent playing of such games may be found in casinos. Casinos offer such card games as traditional table games, at which a dealer deals the cards to multiple players and the players play against the casino (the “house”) or against each other. When the players play against each other, the house usually makes money by taking a percentage of the bets made by the players (sometimes called the “take”). Casinos also offer such card games in electronic form, such as video poker or video blackjack games, in which the player plays against the machine or “computer players” that play according to programming.

Casinos constantly develop variants to the traditional card games mentioned above. Variant games such as the blackjack variants Let it Ride™ and 21™ and others may be seen on many casino floors today. Such variants offer players opportunities to make additional bets beyond those available in the traditional games, increasing their potential winnings. Of course, the variant games and such additional bets are designed with such odds that the casino will make more money than in the traditional games.

Despite the number of variants, the most popular casino table games generally remain Texas Hold-em poker and traditional blackjack. In Texas Hold-em, the dealer deals each player two face down or hole cards. The players, starting one player after the “Big Blind,” commence a round of betting in which players may call the Big Blind, fold their hand or raise the bet. Only those that call the high bet (either the Big Blind or a raise) remain in the hand. The dealer then deals three community cards and another round of betting occurs. If players remain after the round of betting, a fourth community card is dealt, another round of betting occurs. If players remain, a fifth community card is dealt and final round of betting remains. The player who either is the last one remaining (all other players fold their hand) or the player with the best five card hand using their hole cards and/or the five community cards wins the hand. The winner gets the “pot” (the combination of all bets made in the hand). In tie hands, the winners share the pot.

What is needed is a game that combines the features of Texas Hold-em and blackjack.

### SUMMARY

Embodiments described herein overcome the disadvantages of the prior art. These and other advantages are achieved by, for example, a method for playing blackjack hold-em that includes receiving a buy-in from each player, calculating a unit, wherein the unit is the value of each hand, calculating total units needed to win a game, dealing player hold cards, wherein the hold cards are dealt face-down, receiving one or more requests for hit cards, wherein the hit cards are dealt face up, instructing each player to turn over their hold cards, determining the winning hand or hands, wherein the player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand, and paying the winning hand the appropriate unit(s) or unit fraction, minus any house take.

These advantages and others are achieved by, for example, a method for playing blackjack hold-em that includes receiving a buy-in from each player, calculating a unit, wherein the unit is the value of each hand, calculating total units needed to win a game, dealing player hold cards, wherein the hold cards are dealt face-down, providing a round of betting wherein bets may be received from one or more players and the bets may be in unit increments that increase the value of the hand, dealing hit cards to players remaining after the round of betting that request hit cards, instructing each player to turn over their hold card, determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand, and paying the winning hand the appropriate unit(s) or unit fraction, minus any house take.

These advantages and others are achieved by, for example, a method for playing blackjack hold-em that includes receiving a buy-in from each player, providing a stack of chips to each player, setting initial blinds, receiving blind bets from a big blind player and a small blind player, dealing player hold cards, wherein the hold cards are dealt face-down, providing a round of betting, wherein the betting starts with the player to the immediate left of the big blind, dealing hit cards to players remaining after the round of betting that request hit cards, providing an additional round of betting, determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and paying the winning hand the appropriate unit(s) or unit fraction, minus any house take.

These advantages and others are achieved by, for example, a method for playing blackjack hold-em that includes receiving a buy-in from each player, providing a stack of chips to each player, setting initial blinds, receiving blind bets from a big blind player and a small blind player, dealing player hold cards, wherein the hold cards are dealt face-down, providing a round of betting, wherein the betting starts with the player to the immediate left of the big blind, dealing hit cards to players remaining after the round of betting that request hit cards, wherein the hit cards are dealt to each player one at a time after that player bets, providing an additional round of betting if any players received a hit card in, repeating the preceding steps until no players request additional hit cards, determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and paying the winning hand the appropriate unit(s) or unit fraction, minus any house take.

These advantages and others are achieved by, for example systems and computer readable mediums containing instructions that when executed perform the above-described methods.

### BRIEF DESCRIPTION OF THE DRAWINGS

The detailed description will refer to the following drawings, wherein like numerals refer to like elements, and wherein:

FIG. 1 is a flowchart illustrating an embodiment of a method for a blackjack hold-em game.

FIG. 2 is a flowchart illustrating an embodiment of a method for a blackjack hold-em game.

FIG. 3 is a flowchart illustrating an embodiment of a method for a blackjack hold-em game.

FIG. 4 is a flowchart illustrating an embodiment of a method for a blackjack hold-em game.

FIG. 5 is a flowchart illustrating an embodiment of a method for a blackjack hold-em game.

FIG. 6 is a block diagram illustrating embodiments of a system for implementing embodiments of a method for a blackjack hold-em game.

FIG. 7 is a diagram illustrating an embodiment of table for implementing embodiments of a method for a blackjack hold-em game.

### DETAILED DESCRIPTION

Described herein are embodiments of a system and method for a blackjack hold-em game. Embodiments provide numerous variants of a game combining features of traditional blackjack and Texas Hold-em poker games. The embodiments provide a new, interesting game that will provide players with hours of entertainment and challenge. The embodiments also provide casinos with a new source of revenue, in both table game and computerized/electronic form.

In embodiments described herein, a multiplayer blackjack game is provided in which each player competes against every other player at the table. In certain embodiments, each hand is worth a number of points and the overall winner is determined by the first to reach a set number of points through a cumulative scoring system. For example, each hand may be worth one (1) unit and the game won by the first player to reach ten (10) units. Players may participate in the game by placing an initial buy-in at the beginning of the game. The total of these buy-ins may be referred to as the pot. A unit may be a set amount of money (e.g., $10) and may be based on the pot (e.g., each unit is a integer fraction of the pot). Tie hands may see the unit split among the winners or the unit carried over until the next game, similar to “skins” in a skin golf game. Variants of these embodiments may see players make bets at various points in the game to increase the units at stake in the game. Players may be limited to making bets based on the units they have won up to that point in the game or by units remaining from an initial starting stack of units. The winners of games played according to these embodiments may take a prize determined by the initial pot or by simply keeping the units they have won. Players that finish behind the winner may also receive various prizes based on their position or simply the units they have earned or have remaining when the game is won. The house may take a percentage of the betting pot (the “take”). The house percentage may vary based on the size of the pot and may be limited to a percentage of the pot up to a certain amount.

In other embodiments, there are numerous rounds for making bets, such as in Texas Hold-em, and each hand is won by the only player remaining after the rounds of betting or the player with the best hand, with the winner getting the “pot” (the combination of all bets made in the hand) minus the take. In tie hands, the winners share the pot, minus the take. The house may take a percentage of the pot on each hand, a percentage of the units gambled on each hand (including additional bets) or a percentage of the amounts paid out when the game is won. The house percentage may vary based on the size of the pot and may be limited to a percentage of the pot up to a certain amount.

With reference now to FIG. 1, shown is an embodiment of a method 100 for a blackjack hold-em game. Method 100 may start with a buy-in being received from each player, block 102. For example, a dealer may announce the buy-in amount and ask each player to pay the buy-in. The buy-in may be collected in gambling chips (each representing a certain amount of money), cash or other methods of payment. The total buy-ins collected 102 is the pot for the game. Method 100 may calculate or determine the “unit,” i.e., the value of each hand, block 104. The unit may be calculated 104 prior to or after the pot being collected and may be, alternatively, used to determine the buy-in and the pot. Method 100 may also calculate or determine the total units needed to win the game, block 106. The total units needed to win the game may be calculated 106 based on the pot and the total number of players.

After the pot has been collected 102, the player hands, or hold cards, are dealt face down, block 108. The player to the immediate left of the dealer, the “on the button player,” may be dealt first. After each player checks their hold cards, they may request one or more additional cards (each card a “hit”), starting with the on the button player. The hit cards may be dealt face up, block 110. The hit cards are typically dealt to one card at a time and one player at a time, with each player receiving as many face cards as they request, one at a time, before moving on to the next player. Players must not request additional cards if the total value of their cards (both in the hole and face up) equals or exceed twenty-one (21) (with face cards having a value of ten, aces a value of one or eleven, and all other cards having the same value as stated on the car (e.g., a 2 of any suit has a value of two (2), a 3 of any suit has a value of three (3), etc.)). Players may stop requesting hit cards at any point prior to reaching a total of twenty-one (21). If a player's hand exceeds twenty-one (21) they do not have to fold their hand, as their hand may still be the best hand. With continuing reference to FIG. 1, when the last player has refused any more hits, all of the players turn over their hold cards. The winning hand or hands are determined, block 112. The player with a total card value closest to twenty-one (21) without exceeding twenty-one (21) wins the hand. If two players tie for the closest value to twenty-one (21), those players tie. If any player has a natural blackjack, i.e., their two hole cards equal twenty-one (21) (i.e., they have an ace and a ten or face card), they win the hand unless someone else also has a natural blackjack. If no players are equal to or below twenty-one (21) (i.e., all the players have “bust” hands), the player with the smallest total value wins the hand. Alternatively, if all players have bust hands, the hand may be declared a push or bust hand. Method 100 may pay or award the winning hand the appropriate unit(s) or unit fraction, block 114. The unit or unit fraction may be awarded to the winning player by actually providing the winning player chips equaling the unit or unit fraction. If two (2) or more players tie, the unit may be divided between the tying players. Alternatively, if two (2) or more players tie or if the hand is a bust hand, the unit value of the hand may be carried over to the next hand (e.g., as in skin golf games). Method 100 may determine if any player has reached the set total units needed to win the game (i.e., if their cumulative total units equals or exceeds the set winning total of units), block 116. If a player has reached the set total units, the game is over. If no player has reached the set total units, method 100 deals 108 the next hand.

With reference now to FIG. 2, shown is another embodiment of a method 200 for a blackjack hold-em game. Method 200 is similar to method 100, particularly as to the initial set-up, but differs in the play particularly as to betting. Method 200 may start with a buy-in being received from each player, block 202, as described above. Method 200 may calculate or determine the “unit,” i.e., the value of each hand, block 204. Method 200 may also calculate or determine the total units needed to win the game, block 206. The total units needed to win the game may be calculated 206 based on the pot and the total number of players.

After the pot has been collected 202, the player hands, or hold cards, are dealt face down, block 208. After each player checks their hold cards, they may request one or more hit cards. The hit cards may be dealt face up, block 210, as described above. After the hit cards are dealt 210, method 200 may provide a round of betting on that hand, block 212. Betting may begin with the player to the immediate left of the dealer. Players may make bets to increase the unit value for the given hand. For example, the on the button player may bet to increase the unit value for a given hand to two (2) units. Each player may have the option to call the bet and stay in the hand, fold and get out of the hand or make a raise further increasing the unit value of the hand. A maximum increase in units for each bet and for each hand may be set (similar to limit hold-em) or there may be no-limit. If there is a limit, the maximum units per hand may be set less than the cumulative total needed to win the game. Only those players that call the bet and any additional raises may win that hand. The disadvantage of making and calling bets to increase the unit value of the hand is that those players who make or call the bets may lose the increased unit value from their cumulative total.

In an alternative embodiment of method 200, hit cards are dealt 210 in rounds, with one card to each player requesting a hit card, and a round of betting is provided 212 after each round of hit cards are dealt 210. In this manner, additional opportunities are provided for players to increase the unit value of the hand.

With continuing reference to FIG. 2, when the last player has refused any more hits and all bets have been called (or no players remain other than last raising bettor), all of the remaining players turn over their hold cards. The winning hand or hands are determined, block 214. If only one player remains, that player has the winning hand. Otherwise, the winner may be determined as described above with reference to FIG. 1. Method 200 may pay or award the winning hand(s) the appropriate unit(s) or unit fraction, block 216, as described above. If, at any point, only one player remains, that player has the winning hand and the method 200 proceeds to pay 216 the winner, skipping intervening steps.

Method 200 may also deduct the hand's unit value from the cumulative total of units of those players that made or called bets increasing the hand's unit value and lost the hand, block 218. After deducting the hand's unit value, a player's cumulative total units may be a negative number. Method 200 may determine if any player has reached the set total units needed to win the game, block 220. If a player has reached the set total units, the game is over. If no player has reached the set total units, method 200 deals 208 the next hand.

With reference now to FIG. 3, shown is another embodiment a method 300 for a blackjack hold-em game. Method 300 is similar to method 100 and method 200 in the manner of playing, but differs as to how bets are placed and winners are determined. In method 300, betting is similar to a Texas hold-em game in which there may be an initial blind value and there are multiple rounds of betting after each round of card dealing. In method 300, a game may be played as a “cash” game, where players buy-in for a stack of chips, players may purchase additional chips, where blinds remain steady and players may join or leave at any point or when they exhaust their chips and do not decide to purchase additional chips. Alternatively, a game may be played as a tournament game, where players buy-in at a set amount and receive a stack of chips, the blinds increase over time and players may only leave when they exhaust their stack of chips. Method 300 may start with a buy-in being received from each player, block 302, and a stack of chips being provided to each player, block 304. Method 300 may set the initial blinds, block 306.

The two players to the immediate left of the dealer place a “small blind” and “big blind” bet, respectively, block 308 (in online, mobile or other computerized version, the blinds are received). After each hand, the small blind and big blind move one space to the left, as in hold-em poker (in other words, the “dealer position” moves one space to the left, although the house dealer never actually moves). Alternatively, an ante may also be collected from each player. After the blinds are placed, and any ante collected, the dealer deals the initial two cards, or hold cards, face down, block 310. A round of betting is provided, starting with the player to the immediate left of the big blind, block 312. As in Texas Hold-em, a player may fold, call the big blind (i.e., make a bet equal to the big blind) or raise the big blind (make a bet larger than the big blind). The house may set rules for raises similar to Texas Hold-em, such as that the minimum raise is an amount equal to the big blind or the last raise. Each player in turn, proceeding clockwise, may fold, call or raise the previous bet. Any players remaining may then may request one or more hit cards. The hit cards may be dealt face up, block 314, as described above. After the hit cards are dealt 314, method 300 may provide an additional round of betting on that hand, block 316. In the second round of betting and later rounds, if any, betting may begin with the first player remaining to the immediate left of the dealer. Players may make bets to increase the unit value for the given hand. Betting may proceed as in the first round of betting or otherwise described herein.

With continuing reference to FIG. 3, when the last player has refused any more hits and all bets have been called (or no players remain other than last raising bettor), all of the remaining players turn over their hold cards. The winning hand or hands are determined, block 318. Ties may be broken as described above or by simply splitting the pot. Method 300 may pay the winner or winners, block 320. If, at any point, only one player remains, that player has the winning hand and the method 300 proceeds to pay 320 the winner, skipping intervening steps.

Method 300 may also include raising the blinds, block 322. In a tournament style blackjack hold-em game, blinds may be increased 322 in order to eliminate players from the tournament. A player may play in the tournament only as long as they have chips left. Some tournaments, like poker tournaments, may provide for re-buys, allowing a player to purchase more chips during the course of play.

With reference now to FIG. 4, shown is another method 400 for a blackjack hold-em game. Method 400 is a variant of method 300. Method 400 may start with a buy-in being received from each player, block 402, and a stack of chips being provided to each player, block 404 (in online, mobile or other computerized version, a virtual stack of chips or other denotation of chips is provided). Method 400 may set the initial blinds, block 406. The two players to the immediate left of the dealer place a “small blind” and “big blind” bet, respectively, block 408. Alternatively, an ante may also be collected from each player. After the blinds are placed, and any ante collected, the dealer deals the initial two cards, or hold cards, face down, block 410. A round of betting is provided, starting with the player to the immediate left of the big blind, block 412. As in Texas Hold-em, a player may fold, call the big blind (i.e., make a bet equal to the big blind) or raise the big blind (make a bet larger than the big blind). The house may set rules for raises similar to Texas Hold-em, such as that the minimum raise is an amount equal to the big blind or the last raise.

The hit cards may be dealt face up, block 414, as described above. In method 400, however, each player requests their one or more hit cards, and completes taking hit cards, before the next player bets. Accordingly, the round of betting 412 and the dealing 414 of hit cards occur together and is repeated for each player, block 415. After each player makes their bet and receives one or more hit cards, if any, the next player bets, as described above. After all the hit cards are dealt 414, a final round of betting may be provided, block 416, as described above.

With continuing reference to FIG. 4, when the last player has refused any more hits and all bets have been called (or no players remain other than last raising bettor), all of the remaining players turn over their hold cards. The winning hand or hands are determined, block 418. If only one player remains, that player has the winning hand. Ties may be broken as described above or by simply splitting the pot. Method 400 may pay the winner or winners, block 420.

Method 400 may also include raising the blinds, block 422. In a tournament style blackjack hold-em game, blinds may be increased 422 in order to eliminate players from the tournament. A player may play in the tournament only as long as they have chips left. Some tournaments, like poker tournaments, may provide for re-buys, allowing a player to purchase more chips during the course of play.

With reference now to FIG. 5, shown is shown another method 500 for a blackjack hold-em game. Method 500 is a variant of methods 300 and 400. Method 500 may start with a buy-in being received from each player, block 502, and a stack of chips being provided to each player, block 504. Method 500 may set the initial blinds, block 506. The two players to the immediate left of the dealer place a “small blind” and “big blind” bet, respectively, block 508. Alternatively, an ante may also be collected from each player. After the blinds are placed, and any ante collected, the dealer deals the hold cards, face down, block 510. A round of betting is provided, starting with the player to the immediate left of the big blind, block 512. As in Texas Hold-em, a player may fold, call the big blind (i.e., make a bet equal to the big blind) or raise the big blind (make a bet larger than the big blind). The house may set rules for raises similar to Texas Hold-em, such as that the minimum raise is an amount equal to the big blind or the last raise.

After the round of betting 512, one hit card is dealt to each remaining player that requests a hit card, block 514. If any player receives a hit card, a second round of betting may be provided, block 516, starting with the first remaining player to the dealer's left. Another hit card may be dealt to each remaining player that requests a hit card, block 518, starting with the first remaining player to the dealer's left. If any player receives a hit card, a third round of betting may be provided, block 520, starting with the first remaining player to the dealer's left. These steps may be repeated until no player requests an additional hit card. After the final round of betting, all of the remaining players turn over their hold cards. The winning hand or hands are determined, block 522. If only one player remains, that player has the winning hand. Ties may be broken as described above or by simply splitting the pot. Method 500 may pay the winner or winners, block 524. As with all of the above methods, if at any point only one player remains, that player is declared the winner.

Method 500 may also include raising the blinds, block 526. In a tournament style blackjack hold-em game, blinds may be increased 526 in order to eliminate players from the tournament. A player may play in the tournament only as long as they have chips left. Some tournaments, like poker tournaments, may provide for re-buys, allowing a player to purchase more chips during the course of play.

As is illustrated by the above description and drawings, there are many possible variations of blackjack hold-em. Additional embodiments combining various features of the embodiments described above may be implemented. Likewise, variations of the play of blackjack hold-em described above may also be implemented. For example, the hit cards may be dealt face-down. Likewise, a round of betting may be provided for after dealing one hole card.

Moreover, while the methods illustrated in FIGS. 1-5 and have been primarily described as a table game, these methods may be implemented as computerized methods, either in a standalone, programmed gaming device or as a computer program that may be loaded onto any computing device (e.g., desktop computer, laptop/notebook/netbook computer, tablet computer (e.g., iPod™), smart-phone (e.g., iPhone™ or Droid™ phone), electronic book device (e.g., Nook™ or Kindle™) or other mobile computing device (e.g., iPod™). These methods may be implemented as computerized methods in which the user plays against the computer, against simulated “computer” players or against other players playing on networked computing devices (e.g., through telecommunication network, Internet, WiFi, hard-wired, or other network connections).

For example, a casino may have a series of networked blackjack hold-em gaming devices. A player using one of these gaming devices may play against other players on the other networked gaming devices, against the computer, or against multiple simulated computer players. Likewise, a player using a computer program on, e.g., an iPhone™, may play against other players using other iPhones™ or other mobile computing devices, via a network, against the computer, or against multiple simulated computer players.

With reference now to FIG. 6, shown is a block diagram illustrating a system 60 that includes one or more networked computing devices or systems 600. System 60 may include a server computing device 600 to make the connections and/or run the game on multiple client or otherwise networked computing devices 600. Computing system 600, including client-servers combining multiple computer systems, or other computer systems similarly configured, may include and execute one or more subsystem components to perform functions described herein, including steps of methods and processes described above. Computer system 600 may connect with network 622, e.g., Internet, or other network, to receive inquires, obtain data, and transmit information and incentives as described above.

Computer system 600 typically includes a memory 602, a secondary storage device 604, and a processor 606. Computer system 600 may also include a plurality of processors 606 and be configured as a plurality of, e.g., bladed servers, or other known server configurations. Computer system 600 may also include an input device 608, a display device 610, and an output device 612. Memory 602 may include RAM or similar types of memory, and it may store one or more applications for execution by processor 606. Secondary storage device 604 may include a hard disk drive, floppy disk drive, CD-ROM drive, or other types of non-volatile data storage. Processor 606 executes the application(s), such as subsystem components, which are stored in memory 602 or secondary storage 604 or received from the Internet or other network 622 The processing by processor 606 may be implemented in software, such as software modules, for execution by computers or other machines. These applications preferably include instructions executable to perform the system and subsystem component (or application) functions and methods described above and illustrated in the FIGS. herein. The applications preferably provide graphical user interfaces (GUIs) through which users may view and interact with subsystem components (or application in mobile device).

Computer system 600 may store one or more database structures in secondary storage 604, for example, for storing and maintaining databases, and other information necessary to perform the above-described methods. Alternatively, such databases may be in storage devices separate from subsystem components.

Also, as noted, processor 606 may execute one or more software applications in order to provide the functions described in this specification, specifically to execute and perform the steps and functions in the methods described above. Such methods and the processing may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the system (or application).

Input device 608 may include any device for entering information into computer system 600, such as a touch-screen, keyboard, mouse, cursor-control device, touch-screen, microphone, digital camera, video recorder or camcorder. The input device 608 may be used to enter information into GUIs during performance of the methods described above. Display device 610 may include any type of device for presenting visual information such as, for example, a computer monitor or flat-screen display (or mobile device screen). The display device 610 may display the GUIs and/or output from sub-system components (or application). Output device 612 may include any type of device for presenting a hard copy of information, such as a printer, and other types of output devices include speakers or any device for providing information in audio form.

Examples of computer system 600 include dedicated server computers, such as bladed servers, personal computers, laptop computers, notebook computers, palm top computers, network computers, smart phones, mobile devices, or any processor-controlled device capable of executing a web browser or other type of application for interacting with the system.

Although only one computer system 600 is shown in detail, system and method embodiments described herein may use multiple computer system or servers as necessary or desired to support the users and may also use back-up or redundant servers to prevent network downtime in the event of a failure of a particular server. In addition, although computer system 600 is depicted with various components, one skilled in the art will appreciate that the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, computer 600, to perform a particular method, such as methods described above.

With reference now to FIG. 7, shown is an embodiment of a table that may be used to provide a blackjack hold-em game. Very similar to current blackjack tables, the blackjack hold-em table provides space for players to make additional bets after rounds of hit cards as described herein. Blackjack hold-em tables may have designated areas for the placing of such bets. Computerized versions of a blackjack hold-em game may display a similar table on a device screen.

Embodiments of the a system and method for a blackjack hold-em game have been described herein and are set forth in the below claims. Embodiments include a system for playing blackjack hold-em that includes a processor for executing instructions, and a memory that includes instructions, executed by the processor, for receiving a buy-in from each player, calculating a unit, wherein the unit is the value of each hand, calculating total units needed to win a game, dealing player hold cards, wherein the hold cards are dealt face-down, receiving one or more requests for hit cards, wherein the hit cards are dealt face up, instructing each player to turn over their hold cards, determining the winning hand or hands, wherein the player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand, and paying the winning hand the appropriate unit(s) or unit fraction, minus any house take.

Embodiments also include a system for playing blackjack hold-em that includes a processor for executing instructions, and a memory that includes instructions, executed by the processor, for receiving a buy-in from each player, calculating a unit, wherein the unit is the value of each hand, calculating total units needed to win a game, dealing player hold cards, wherein the hold cards are dealt face-down, providing a round of betting wherein bets may be received from one or more players and the bets may be in unit increments that increase the value of the hand, dealing hit cards to players remaining after the round of betting that request hit cards, instructing each player to turn over their hold cards, determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and paying the winning hand the appropriate unit(s) or unit fraction, minus any house take.

Embodiments also include a system for playing blackjack hold-em that includes processor for executing instructions and a memory that includes instructions, executed by the processor, for receiving a buy-in from each player, providing a stack of chips to each player, setting initial blinds, receiving blind bets from a big blind player and a small blind player, dealing player hold cards, wherein the hold cards are dealt face-down, providing a round of betting, wherein the betting starts with the player to the immediate left of the big blind, dealing hit cards to players remaining after the round of betting that request hit cards, providing an additional round of betting, determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand andpaying the winning hand the appropriate unit(s) or unit fraction, minus any house take.

Embodiments also include a system for playing blackjack hold-em that includes a processor for executing instructions and a memory that includes instructions, executed by the processor, for a. receiving a buy-in from each player, b. providing a stack of chips to each player, c. setting initial blinds, d. receiving blind bets from a big blind player and a small blind player, e. dealing player hold cards, wherein the hold cards are dealt face-down, f. providing a round of betting, wherein the betting starts with the player to the immediate left of the big blind, g. dealing hit cards to players remaining after the round of betting that request hit cards, wherein the hit cards are dealt to each player one at a time after that player bets, h. providing an additional round of betting if any players received a hit card in g, i. repeating g to h until no players request additional hit cards, j. determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and k. paying the winning hand the appropriate unit(s) or unit fraction, minus any house take.

Embodiments also include a system for playing blackjack hold-em that includes a processor for executing instructions and a memory that includes instructions, executed by the processor, for a. receiving a buy-in from each player, b. providing a stack of chips to each player, c. setting initial blinds, d. receiving blind bets from a big blind player and a small blind player, e. dealing player hold cards, wherein the hold cards are dealt face-down, f. providing a round of betting, wherein the betting starts with the player to the immediate left of the big blind, g. dealing hit cards to players remaining after the round of betting that request hit cards, wherein the hit cards are dealt to each player one at a time after that player bets, h. providing an additional round of betting if any players received a hit card in g, i. repeating g to h until no players request additional hit cards, j. determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and k. paying the winning hand the appropriate unit(s) or unit fraction, minus any house take.

Embodiments also include a tangible computer readable medium comprising instructions for execution by a processor for playing blackjack hold-em by receiving a buy-in from each player, calculating a unit, wherein the unit is the value of each hand, calculating total units needed to win a game, dealing player hold cards, wherein the hold cards are dealt face-down, receiving one or more requests for hit cards, wherein the hit cards are dealt face up, instructing each player to turn over their hold cards, determining the winning hand or hands, wherein the player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and paying the winning hand the appropriate unit(s) or unit fraction, minus any house take.

Embodiments also include a tangible computer readable medium comprising instructions for execution by a processor for playing blackjack hold-em by receiving a buy-in from each player, calculating a unit, wherein the unit is the value of each hand, calculating total units needed to win a game, dealing player hold cards, wherein the hold cards are dealt face-down, providing a round of betting wherein bets may be received from one or more players and the bets may be in unit increments that increase the value of the hand, dealing hit cards to players remaining after the round of betting that request hit cards, instructing each player to turn over their hold cards, determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and paying the winning hand the appropriate unit(s) or unit fraction, minus any house take.

Embodiments also include a tangible computer readable medium comprising instructions for execution by a processor for playing blackjack hold-em by receiving a buy-in from each player, calculating a unit, wherein the unit is the value of each hand, calculating total units needed to win a game, dealing player hold cards, wherein the hold cards are dealt face-down, providing a round of betting, wherein the betting starts with the player to the immediate left of the big blind, dealing hit cards to players remaining after the round of betting that request hit cards, providing an additional round of betting, determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and paying the winning hand the appropriate unit(s) or unit fraction, minus any house take.

Embodiments also include a tangible computer readable medium comprising instructions for execution by a processor for playing blackjack hold-em by a. receiving a buy-in from each player, b. providing a stack of chips to each player, c. setting initial blinds, d. receiving blind bets from a big blind player and a small blind player, e. dealing player hold cards, wherein the hold cards are dealt face-down, f. providing a round of betting, wherein the betting starts with the player to the immediate left of the big blind, g. dealing hit cards to players remaining after the round of betting that request hit cards, wherein the hit cards are dealt to each player one at a time after that player bets, h. providing an additional round of betting if any players received a hit card in g, i. repeating g to h until no players request additional hit cards, j. determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and k. paying the winning hand the appropriate unit(s) or unit fraction, minus any house take.

Embodiments also include a tangible computer readable medium comprising instructions for execution by a processor for playing blackjack hold-em by a. receiving a buy-in from each player, b. providing a stack of chips to each player, c. setting initial blinds, d. receiving blind bets from a big blind player and a small blind player, e. dealing player hold cards, wherein the hold cards are dealt face-down, f. providing a round of betting, wherein the betting starts with the player to the immediate left of the big blind, g. dealing hit cards to players remaining after the round of betting that request hit cards, wherein the hit cards are dealt to each player one at a time after that player bets, h. providing an additional round of betting if any players received a hit card in g, i. repeating g to h until no players request additional hit cards, j. determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand and k. paying the winning hand the appropriate unit(s) or unit fraction, minus any house take.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A method for playing blackjack hold-em, comprising:
a. receiving a buy-in from each player;
b. calculating a unit, wherein the unit is the value of each hand;
c. calculating total units needed to win a game;
d. dealing player hold cards, wherein the hold cards are dealt face-down;
e. receiving one or more requests for hit cards, wherein the hit cards are dealt face up;
f. instructing each player to turn over their hold cards;
g. determining the winning hand or hands, wherein the player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand; and
h. paying the winning hand the appropriate unit(s) or unit fraction, minus any house take.

2. The method of claim 1 further comprising determining if a player has reached the set total units needed to win the game.

3. The method of claim 2 wherein if a player is determined to have reached the set total units needed to win the game, the method further comprises declaring the game over.

4. The method of claim 2 wherein if no player has reached the set total units, the method repeats d. to h.

5. The method of claim 1, wherein the method is a computer-implemented method in which a processor executes instructions in a memory to perform a. to h.

6. A method for playing blackjack hold-em, comprising:
a. receiving a buy-in from each player;
b. calculating a unit, wherein the unit is the value of each hand;
c. calculating total units needed to win a game;
d. dealing player hold cards, wherein the hold cards are dealt face-down;
e. providing a round of betting wherein bets may be received from one or more players and the bets may be in unit increments that increase the value of the hand;
f. dealing hit cards to players remaining after the round of betting that request hit cards;
g. instructing each player to turn over their hold cards;
h. determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand; and
i. paying the winning hand the appropriate unit(s) or unit fraction, minus any house take.

7. The method of claim 6 further comprising determining if a player has reached the set total units needed to win the game.

8. The method of claim 7 wherein if a player is determined to have reached the set total units needed to win the game, the method further comprises declaring the game over.

9. The method of claim 7 wherein if no player has reached the set total units, the method repeats d. to i.

10. The method of claim 6 wherein the hit cards are dealt in rounds, with one card to each player requesting a hit card and the method further comprises providing a round of betting after each round of hit cards are dealt.

11. The method of claim 6, wherein the method is a computer-implemented method in which a processor executes instructions in a memory to perform a. to i.

12. A method for playing blackjack hold-em, comprising:
a. receiving a buy-in from each player;
b. providing a stack of chips to each player;
c. setting initial blinds;
d. receiving blind bets from a big blind player and a small blind player;
e. dealing player hold cards, wherein the hold cards are dealt face-down;
f. providing a round of betting, wherein the betting starts with the player to the immediate left of the big blind;
g. dealing hit cards to players remaining after the round of betting that request hit cards;
h. providing an additional round of betting
i. determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand; and
j. paying the winning hand the appropriate unit(s) or unit fraction, minus any house take.

13. The method of claim 12, further comprising collecting an ante from each player.

14. The method of claim 12 further comprising repeating d to j until the game is completed.

15. The method of claim 14 wherein the game is completed when only one player remains or remaining players agree to end the game.

16. The method of claim 14 wherein the game is completed at a predetermined time.

17. The method of claim 12 wherein the method is a computer-implemented method in which a processor executes instructions in a memory to perform a. to j.

18. A method for playing blackjack hold-em, comprising:
a. receiving a buy-in from each player;
b. providing a stack of chips to each player;
c. setting initial blinds;
d. receiving blind bets from a big blind player and a small blind player;
e. dealing player hold cards, wherein the hold cards are dealt face-down;
f. providing a round of betting, wherein the betting starts with the player to the immediate left of the big blind;
g. dealing hit cards to players remaining after the round of betting that request hit cards, wherein the hit cards are dealt to each player one at a time after that player bets;
h. providing an additional round of betting if any players received a hit card in g.
i. repeating g to h until no players request additional hit cards;
j. determining the winning hand or hands, wherein the remaining player with a total card value closest to twenty-one (21) without exceeding twenty-one (21) wins the hand, if two players tie for the closest value to twenty-one (21), those players tie, if any player's two hole cards equal twenty-one (21) that player wins the hand unless another player's two hole cards equal twenty-one (21), and if no players are equal to or below twenty-one (21), the player with the smallest total value wins the hand; and
k. paying the winning hand the appropriate unit(s) or unit fraction, minus any house take.

19. The method of claim 18, further comprising collecting an ante from each player.

20. The method of claim 18 further comprising repeating d to k until the game is completed.

21. The method of claim 20 wherein the game is completed when only one player remains or remaining players agree to end the game.

22. The method of claim 20 wherein the game is completed at a predetermined time.

23. The method of claim 18 wherein the method is a computer-implemented method in which a processor executes instructions in a memory to perform a. to k.
